(19) United States
(12) Patent Application Publication
(10) Pub. No.: US 2004/0246585 A1
(43) Pub. Date: Dec. 9, 2004

(54) Kaleidoscope

(76) Inventor: Yoshiharu Mizoguchi, Shizuoka (JP)

Correspondence Address: WENDEROTH, LIND & PONACK, L.L.P., 2033 K STREET N. W., SUITE 800, WASHINGTON, DC, 20006-1021, US

(21) Appl. No.: 10/859,996

(22) Filed: Jun. 4, 2004

(30) Foreign Application Priority Data
Jun. 5, 2003 (JP) 2003-160884

(51) Int. Cl. G02B 27/08; B65D 85/00

(52) U.S. Cl. 359/617

(57) ABSTRACT

A kaleidoscope is disclosed, which comprises a tubular casing extending longitudinally and having an observation window or peephole on its rear end, a closed box on its front end, and a mirror system inside it, wherein the closed box has its opposite ends closed by respective light transmitting elements, and contains lots objects or chips of colored glass or like that can be moving around inside the closed box.

According to the present invention, the closed box is internally divided into several compartments that are delimited by partitions extending longitudinally of the closed box so that the compartments can be separated from each other and kept independent of each other. Each of the compartments contains lots of objects that can be moving around inside it.

### BACKGROUND OF THE INVENTION

1. Field of the Invention

The present invention relates to a kaleidoscope.

2. Description of Related Art

Typically, one conventional type of the kaleidoscope comprises a tubular casing extending longitudinally and having a mirror system inside it, an observation window or peephole on its rear end, and a closed box on its front end, wherein the mirror system includes several sheets of mirror, e.g., three sheets of mirror assembled into a triangle tubular shape in such a manner that each sheet of mirror can have a reflective surface on its inner side, and the closed box has its opposite ends (front and rear ends) closed by respective light transmitting elements and contains lots of objects usually in the form of loose chips of colored glass or like so that the objects can be moving around inside the closed box as the closed box is rotated.

When the user uses such a type of the kaleidoscope as described above, the user holds the tubular casing by his hand or hands, and may then look into it through the observation window or peephole on its rear end while rotating the closed box together with tubular casing or rotating the closed box. When the closed box together with tubular casing is rotating or the closed box is rotating, the objects inside the closed box are rotating and moving around inside the closed box, so that the user can show ever-changing symmetrical patterns through the observation window or peephole. In this way, the user can enjoy viewing such ever-changing symmetrical patterns through the observation window.

Another conventional type of the kaleidoscope is disclosed in Japanese patent application as now published under No. H11 (1999)-223794, in which the closed box may be rotated relative to the tubular casing.

More specifically, this type of the kaleidoscope disclosed in JP-A-H11 (1999)-223794, comprises a tubular casing extending longitudinally and having a mirror system inside it, an observation window or peephole on its rear end, and a closed box on its front end, wherein the closed box is rotatable relative to the tubular casing. Thus, this kaleidoscope provides the ease of use, since the user can only rotate the closed box without having to rotate the tubular casing.

In either of the two conventional types of the kaleidoscope described above, the closed box is not internally divided into several compartments, but rather such one closed box is simply provided on the front end of the tubular casing. Thus, when either the closed box is rotated with the tubular casing, or the closed box is rotated relative to the tubular casing, the objects that are contained in the closed box can only be moving around in a disorderly manner inside the closed box. Because of this, the patterns of the objects that the user can view through the observation window or peephole are limited.

### SUMMARY OF THE INVENTION

The present invention addresses the problems associated with the conventional types of the kaleidoscope described earlier, and proposes to provide a kaleidoscope that permits the user to view a variety of more beautiful patterns of the objects through the observation window or peephole as the kaleidoscope is rotated.

In order to solve the above problems, the kaleidoscope proposed by the present invention comprises a tubular casing extending longitudinally and having an observation window or peephole on its rear end, a closed box on its front end, and a mirror system inside it, wherein the closed box has its opposite ends closed (front and rear ends) by respective light-transmitting elements and contains lots of objects that can be moving around inside the closed box. The before described objects are usually in the form of loose chips of colored glass or like.

The kaleidoscope according to the present invention may be provided in several forms of the embodiment that will be described below.

In one form of the embodiment, the closed box may be internally divided into several compartments that are delimited by partitions extending longitudinally of the closed box so that the compartments can be physically separated from each other and can be kept independent of each other. Each of the compartments may contain lots of objects so that the objects can be moving around within each respective compartment and independently of the objects contained in any of the other compartments. In this form of the embodiment, the closed box may be rotated with the tubular casing when the tubular casing is rotated.

In another form of the embodiment, the closed box may be provided on the front end of the tubular casing so that the closed box can be rotated relative to the tubular casing. Similarly to the first form, the closed box may be internally divided into several compartments that are separated from each other by means of partitions extending longitudinally of the closed box. Each of the compartments may contain lots of objects so that the objects can be moving around within each respective compartment and independently of the objects contained in any of the other compartments.

In the before described two forms of the embodiment of the present invention, the front end of the tubular casing refers to the end on the side that is located remotely from the user, and the rear end of the tubular casing refers to the end on the side that is located nearest to the user.

In the before described two forms of the embodiment of the present invention, the objects may include loose chips or bits of glass, paper, jewels, synthetic resin and the like.

In both of the embodiments of the kaleidoscope described above, the closed box may be provided as a dry-type closed box, in which each compartment of the closed box may only contain objects, or the closed box may be provided as an oil-type closed box, in which each compartment may contain objects as well as any liquid such as oil.

Specifically, when the user uses the kaleidoscope according to the before described first form of the embodiment, the user holds the tubular casing by his hand or hands, and may then look into the tubular casing through the observation window or peephole on its rear end while rotating the tubular casing.

When the tubular casing is rotated, the closed box on the front end of the tubular casing may rotate with the tubular casing, and the objects contained in each compartment can be moving around independently of the objects in the other compartments or without interfering with those objects, since the compartments are separated from each other. Thus, the user can view the patterns of the objects in each compartment that are different from those in any of the other compartments.

As compared with the conventional types of the kaleidoscope as described earlier, in which the closed box is not internally divided into several compartments, and such one closed box is simply provided on the front end of the tubular casing, the kaleidoscope in accordance with the present invention permits the user to view the ever-changing beautiful patterns of the objects that can be moving around in the extremely complicated manner within all of the compartments.

The objects that may be contained in each compartment of the closed box may have the same form, weight and like for each different compartment.

Alternatively, the objects that may be contained in each compartment of the closed box may have the different form, weight and like for each different compartment. In this case, the objects in each compartment can be moving around uniquely and differently from those in any of the other compartments. Totally, the user can thus view the more complicatedly changing beautiful patterns of the objects that are moving around within all of the compartments.

Each compartment of the closed box may contain objects as well as any liquid such as oil, and the liquid may be of a different type for each each compartment. In this way, the objects in each different compartment can behave differently from those in any of the other compartment, and more beautiful patterns of the objects can be viewed. The liquid that may be contained in each compartment may be of the same type for all of the compartments, but has the different viscosity for each different compartment, or may be liquids of different types such as water and oil for all of the compartments.

When the objects as well as any particular liquid are contained in each compartment, the liquid may be of the same type for all of the compartments, while the objects may have the different form, weight or like for each different compartment.

Alternatively, the liquid may be of a different type for each different compartment, while the objects may have the different form, weight and like for each different compartment.

In any case, the objects in each compartment can behave uniquely and differently from those in any of the other compartments. As compared with the conventional types of the kaleidoscope described earlier, in which the closed box is not internally divided into several compartments, and such one closed box is simply provided on the front end of the tubular casing, the kaleidoscope in accordance with the present invention permits the user to view the ever-changing beautiful patterns of the objects that may be moving around in the extremely complicated manner within all of the compartments.

According to the kaleidoscope of the present invention, each compartment may contain objects of similar colors, and the colors of the objects contained in each compartment may be different from those in any of the other compartments. Specifically, each compartment may contain objects of similar colors, and may also contain objects of any other colors that are different from those in any of the other adjacent compartments. In this case, the objects of any particular colors that are contained in each different compartment will not mix up with the objects of any other colors in any of the other adjacent compartments.

As compared with the conventional types of the kaleidoscope described earlier, in which the closed box is not internally divided into several compartments, and such one closed box is simply provided on the front end of the tubular casing, the kaleidoscope according to the present invention permits the objects of some similar colors contained in one compartment to be moving around independently of the objects of other similar colors contained in any of the other adjacent compartments, without causing the objects of some similar colors in one compartment to mix up with the objects of other similar colors in any of the other adjacent compartments within a single region in the disorderly fashion. Thus, the user can view more beautiful patterns of the objects through the observation window or peephole.

As the closed box is internally divided into several compartments that are delimited by the partitions extending longitudinally of the close box as described above so that the compartments can be physically separated from each other and can be kept independent of each other, each of the compartments may also have its opposite ends (front and rear ends) closed by the respective light transmitting elements or plates that close the opposite ends (front and rear ends)of the closed box.

The partitions mentioned above may take form of a colorless or colored, transparent or semitransparent partition, or a colored, opaque partition.

In addition to the advantages and functional effects provided by the kaleidoscope according to the first form of the embodiment, the kaleidoscope according to the second form of the embodiment may provide advantages and functional effects in that it provides the ease of use because the user has only to rotate the closed box instead of rotating the tubular casing and then rotating the closed box together with the tubular casing.

It should be understood that the mirror system as referred to above includes mirror elements each having a reflective surface on its inner side and disposed along the length of the tubular casing. The mirror system may the various forms as follows, which should be understood to be included in the scope of the present invention.

(a) the system consisting of two sheets of mirror and one light-absorbing sheet combined into a triangle tubular shape, which may be called the “double-mirror system”.

(b) the system consisting of three sheets of mirror combined into a triangle tubular shape, which may be called the “triple-mirror system”.

(c) the system consisting of three sheets of mirror and one light-absorbing sheet combined into a square tubular shape, which may be called the “rectangular mirror system”.

(d) the system consisting of four sheets of mirror combined into a square tubular shape, which may be called the “four-mirror system”.

(e) the system consisting of four sheets of mirror combined into a diamond tubular shape, that is, the combination of two double-mirror systems but not including the light-absorbing sheet, which may be called the “twin-mirror system”.

(f) the system consisting of three or four sheets of mirror combined into a triangular pyramid shape or square pyramid shape having the top cut off, which may be called the “tapered mirror system”.

(g) the system consisting of a cylindrical mirror, which may be called the “circle mirror system”.

According to the present invention, the closed box is internally divided into several compartments that are separated from each other so that they can be kept independent of each other. Thus, the objects contained in each different compartment will not mix up with the objects contained in any of the other compartments. More specifically, the objects contained in each different compartment can be moving around within each respective compartment, and can only mix up with the objects within the same compartment.

When each different compartment contains objects of similar colors, respectively, and the objects in each different compartment has a particular color that is different from that of the objects in any of the other compartments, the objects of that particular color contained in each respective compartment will not mix up with the objects of any other particular color contained in any of the other compartments.

In addition, the objects contained in each different compartment can behave differently from the objects contained in any of the other compartments.

As compared with the conventional types of the kaleidoscope described earlier, in which the closed box is not internally divided into several compartments, and such one closed box is simply provided on the front end of the tubular casing, the kaleidoscope according to the present invention permits the user to view the ever-changing, complicated beautiful patterns that can be produced by causing the objects to be moving around in the complicated manner within all of the compartments of the closed box as the closed box is rotated.

### BRIEF DESCRIPTION OF THE DRAWINGS

FIG. 1 is a sectional view illustrating one example of the kaleidoscope according to the present invention on an enlarged scale;

FIG. 2 is a side elevation of the kaleidoscope shown in FIG. 1, as viewed from the left lateral side in FIG. 1;

FIG. 3 is a sectional view taken along the line III—III in FIG. 1;

FIG. 4 is a sectional view illustrating another example of the kaleidoscope according to the present invention on an enlarged scale, with some non-critical parts or elements being not shown; and

FIG. 5 illustrates one example of patterns as viewed through the observation window in accordance with the kaleidoscope of the present invention.

### MODES OF EMBODYING THE PRESENT INVENTION

Now, the present invention will be described in further detail in connection with several particular embodiments thereof by referring to the accompanying drawings.

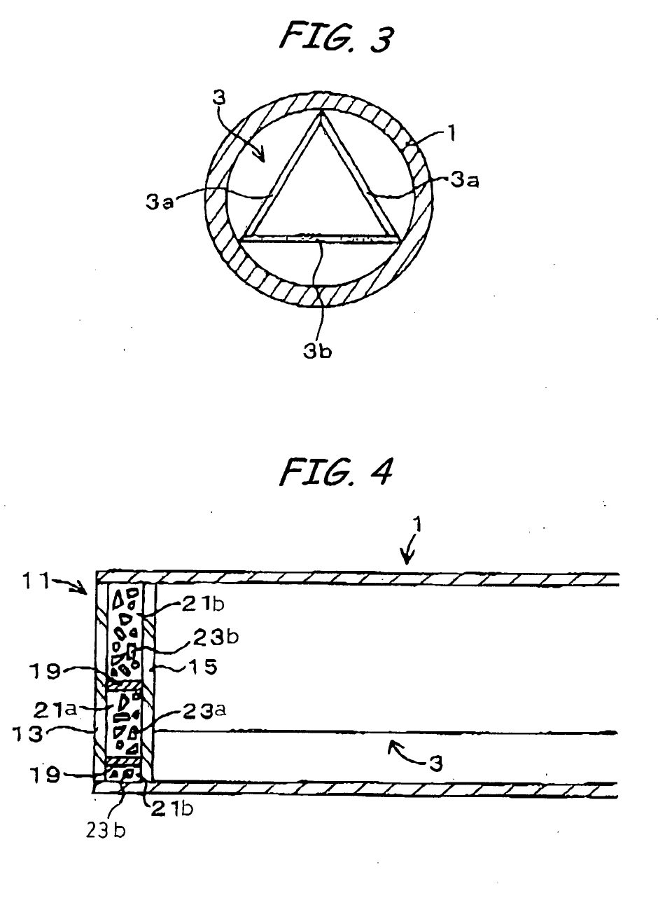

As particularly shown in FIG. 3, the kaleidoscope comprises a tubular casing 1 extending longitudinally and having a mirror system 3 disposed inside it. In the example shown, the tubular casing 1 has the cylindrical form.

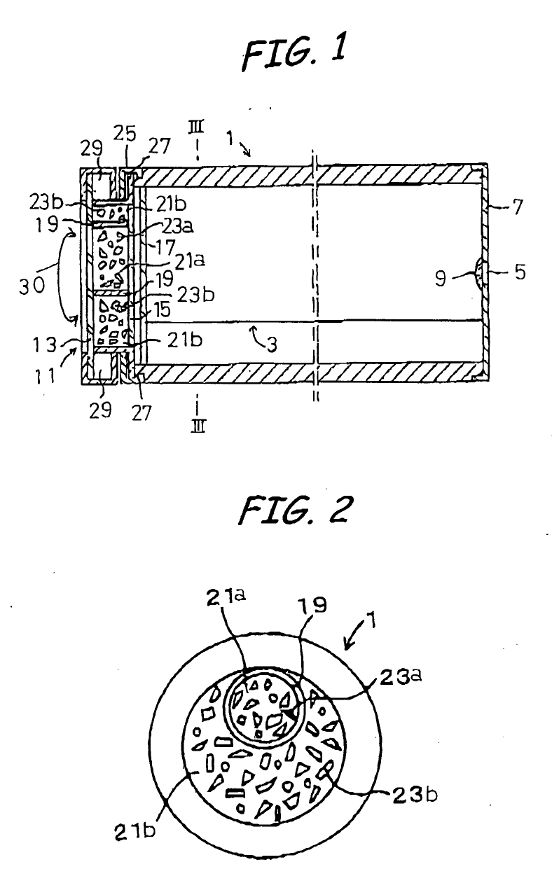

The mirror system 3 includes three mirror elements each having a reflective surface on its inner side and disposed along the length of the tubular casing 1 as shown in FIGS. 1 and 4, that is, two sheets of mirror 3a, 3a and one light absorbing sheet 3b assembled into a triangle tubular form as shown in FIG. 3. A black sheet may be employed as an example of the light absorbing sheet.

The tubular casing 1 further includes an observation window or peephole 5 on its rear end (the end on the right side in FIGS. 1 and 4). The tubular casing 1 has its rear end closed by a rear end plate 7, and the observation window 5 is provided through the center of the rear end plate 7. A lens 9 is provided on the inner side of the observation window 5.

The kaleidoscope further includes a closed box 11 disposed on the front end (the end on the left side in FIGS. 1 and 4) of the tubular casing 1.

The closed box 11 has its opposite ends (front and rear ends) closed by respective light-transmitting elements 13, 15. Each of the light-transmitting elements 13, 15 may take the form of a glass plate, for example.

In the embodiment shown in FIG. 1, it may be seen that there is also a light-transmitting element 17 on the front end (the end on the left side in FIG. 1) of the tubular casing 1. This light-transmitting element 17 may also take the form of a glass plate, for example.

The closed box 11 is internally divided into several compartments, such as compartments 21a, 21b, which are delimited by partitions 19 extending longitudinally of the closed box 11 so that they can be separated from each other and kept independent of each other. In the example shown, the closed box 11 having its opposite ends closed by the respective light transmitting elements 13, 15 is internally divided into two compartments 21a, 21b that are delimited by a cylindrical partition 19 so that they can separated from each other.

Each of the compartments 21a, 21b contains lots of objects 23a, 23b so that those objects 23a, 23b can be moving around within the respective compartment 21a, 21b. It may be understood that the objects 23a in the compartment 21a and the objects 23b in the compartment 21b will not mix up with each other because those compartments are physically separated from each other by means of the cylindrical partition 19.

The objects 23a, 23b may include loose chips or bits of glass, paper, jewels, synthetic resin and the like.

In the embodiment shown in FIG. 4, the closed box 11 is fixed so that it is non-rotational relative to the tubular casing 1.

In the embodiment shown in FIG. 1, the closed box 11 is disposed on the front end of the tubular casing 1 so that it can be rotated relative to the tubular casing 1 as indicated by a double arrow 30.

In the embodiment shown in FIG. 1, the tubular casing 1 has an annular bearing 25 on its front end, and the closed box 11 has a flanged edge 27 on its rear end that is supported rotatably by the annular bearing 25. The closed box 11, which is located on the front end of the tubular casing 1, can thus be rotated relative to the tubular casing 1 as indicated by the double arrow 30.

The part shown by 29 in FIG. 1 is filled with any suitable filler such as putty.

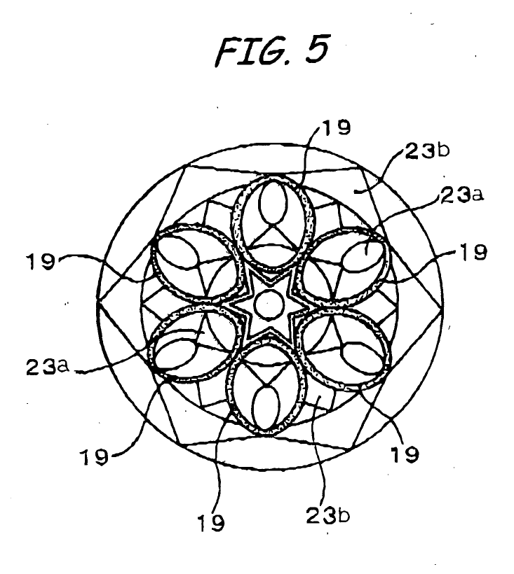

FIG. 5 illustrates how the patterns are changing as viewed through the observation window of the kaleidoscope according to each of the embodiments shown in FIGS. 1 through 3,

Those patterns can be changing every moment as the closed box 11 is rotated.

Although the present invention has been described so far in connection with several preferred embodiments thereof by referring to the accompanying drawings, it should be understood that the present invention is not restricted to those embodiments but various modifications and changes may be made without departing from the spirit and scope of the invention as defined in the appended claims.

What is claimed is:

1. A kaleidoscope comprising a tubular casing extending longitudinally and having an observation window or peephole on its rear end, a closed box on its front end, and a mirror system inside it, the closed box having its opposite ends closed by respective light transmitting elements and containing lots of objects that can be moving around as the closed box is rotated, wherein
the closed box is internally divided into several compartments that are delimited by partitions extending longitudinally of the closed box so that the compartments can be separated from each other and can be kept independent of each other, each of the compartments containing lots of objects that can be moving around within each respective compartment.

2. The kaleidoscope as defined in claim 1, wherein the closed box is disposed on the front end of the tubular casing so that the closed box can be rotated relative to the tubular casing.

3. The kaleidoscope as defined in claim 1, wherein each of the compartments contains objects of similar colors, and the color of the objects contained in each compartment is different from the color of the objects contained in any of the other adjacent compartments.

4. The kaleidoscope as defined in claim 2, wherein each of the compartments contains objects of similar colors, and the color of the objects contained in each compartment is different from the color of the objects contained in any of the other adjacent compartments.

5. The kaleidoscope as defined in claim 1, wherein the objects contained in each of the compartments have the form and weight that are different from those contained in any of the other compartments.

6. The kaleidoscope as defined in claim 2, wherein the objects contained in each of the compartments have the form and weight that are different from those contained in any of the other compartments.

7. The kaleidoscope as defined in claim 1, wherein each of the compartments contains objects as well as any suitable liquid, and the objects contained in each of the compartments have the form and weight that are different from those contained in any of the other compartments.

8. The kaleidoscope as defined in claim 2, wherein each of the compartments contains objects as well as any suitable liquid, and the objects contained in each of the compartments have the form and weight that are different from those contained in any of the other compartments.

9. The kaleidoscope as defined in claim 1, wherein each of the compartments contains objects as well as any suitable liquid, and the liquid contained in each of the compartments is of a type that is different from the liquid contained in any of the other compartments.

10. The kaleidoscope as defined in claim 2, wherein each of the compartments contains objects as well as any suitable liquid, and the liquid contained in each of the compartments is of a type that is different from the liquid contained in any of the other compartments.

11. The kaleidoscope as defined in claim 1, wherein each of the compartments contains objects as well as any suitable liquid, the liquid contained in each of the compartments is of a type that is different from the liquid contained in any of the other compartments, and the objects contained in each of the compartments have the form and weight that are different from those contained in any of the other compartments.

12. The kaleidoscope as defined in claim 2, wherein each of the compartments contains objects as well as any suitable liquid, the liquid contained in each of the compartments is of a type that is different from the liquid contained in any of the other compartments, and the objects contained in each of the compartments have the form and weight that are different from those contained in any of the other compartments.
